(19) United States
(12) Patent Application Publication
(10) Pub. No.: US 2009/0323311 A1
(43) Pub. Date: Dec. 31, 2009

(54) SIDE-EMITTING LED DISPLAY

(76) Inventor: Samir Mezouari, Basildon (GB)

Correspondence Address: FRASER CLEMENS MARTIN & MILLER LLC, 28366 KENSINGTON LANE, PERRYSBURG, OH, 43551, US

(21) Appl. No.: 12/436,429

(22) Filed: May 6, 2009

(30) Foreign Application Priority Data
Jun. 27, 2008 (GB) 0811866.3

(51) Int. Cl. F21V 13/08

(52) U.S. Cl. 362/97.1

(57) ABSTRACT

A display unit is disclosed. The display unit includes a display panel having a graphical information display area for displaying graphical information to a user of the unit, a diffusing means including a primary diffusing reflector and a secondary diffusing reflector disposed adjacent the display panel, wherein the primary diffusing reflector extends transversely away from the display panel, and a source of optical radiation spaced from the diffusing means, the source of optical radiation having an emitting side that faces in a lateral direction with respect to the extent of the display panel and towards the primary diffusing reflector and so that optical radiation from the source of optical radiation is directed toward the primary diffusing reflector.

### CROSS-REFERENCE TO RELATED APPLICATION

This application claims the benefit of United Kingdom Patent Application No. 0811866.3 filed on Jun. 27, 2008, hereby incorporated herein by reference in its entirety.

### FIELD OF THE INVENTION

The present invention related to the field of the illuminating of displays, and in particular to displays having a back-lit display medium.

### BACKGROUND OF THE INVENTION

Displays are often provided with backlighting, used to provide illumination through clear or translucent portions of components forming the display. Examples include liquid crystal displays (LCD's), or indication displays having an appliqué with transparent or translucent portions through which the backlit illumination passes.

Examples in the field of automotive displays include LCD displays for displaying alphanumeric of graphical information, and speedometer or engine speed (rpm) displays having translucent numeric indications.

Traditionally, such displays have been illuminated with incandescent bulbs, although with the emergence of solid state light sources, there has been a considerable increase in the usage of light emitting diodes (LEDs), both colored and white LEDs, because of their compact size and long lifetime.

The display is usually part of a display module seated inside a dashboard assembly. The depth for the display module may be limited because of the space required behind the display for wiring or ducting, and in any event it is desirable to limit the depth of the display.

Display modules comprise normally a rigid or flexible printed circuit carrier, for example printed flex strip or a rigid printed circuit board (PCB) with conduction tracks and components on one or both sides. The number of light sources required to evenly illuminate a graphical information area of vehicle instrument clusters is proportional to the surface area of the graphics. Conventionally, to provide even backlight illumination over an area of a typical automotive dashboard display, and array of LEDs is used beneath the graphical area even illumination. The use of multiple LEDs may also be desirable because then there can be some overlap between the illumination provided by the LEDs.

White LED's are, however, considerably more expensive than incandescent bulbs, and so it is in almost all causes uneconomic simply to replace each incandescent light with an LED. To reduce cost, fewer LEDs may be used but at the expense of sacrificing the illumination homogeneity. The manufacturing process for white LED's also leads to some inevitable hue variation in the shade of white produced by different LED's. This can lead to unpredictable color variations across a backlit display. Therefore, the use of white LED's in backlit display applications has in practice been limited to small area displays both for reasons of cost and for color uniformity.

Most conventional instrument clusters are illuminated using several light sources arranged into a circular array of LED sources beneath the graphical information area. One way to reduce the number of LED sources is to use a balancing technique. The balancing consists on darkening the bright spots to the level of the low brightness spots but this method suffers from a noticeable colour shift that occurs when a polychromatic source is employed such as white light which is due to the difference in the spectrum of absorption of light induced by the additional painting or darkening layers.

Another way to reduce further the number of LED sources used, and therefore the cost, whilst maintaining a uniform distribution of light over a given area, is to use light guides. Light guide solutions are disclosed in JP 2001281008 and US 20040228104. Such techniques efficiently use the available optical power of an LED but require additional design, assembly and tooling costs. Furthermore, light guides are not scalable as these need to be precisely designed for each application and depend critically on the size of the area to be illuminated.

Another solution is to use indirect illumination as disclosed in U.S. Pat. No. 6,595,667, WO 9926809, and WO2005002903. The indirect illumination employs fewer LED sources that are located near the center of the gauge where the emitted light is reflected and diffused in the outward direction by a diffusing deflector. The drawback of this method is that part of the light emitted by the LED is transmitted without being diffused or reflected by the diffusing reflector, and therefore produces uneven illumination and color shift.

It would be desirable to develop a backlit display that maintains a suitable illumination homogeneity while minimizing the number of required light sources.

### SUMMARY OF THE INVENTION

Concordant and consistent with the present invention, a backlit display that maintains a suitable illumination homogeneity while minimizing the number of required light sources, has surprisingly been discovered.

In one embodiment, a display unit comprises: a display panel including a graphical information display area for displaying graphical information to a user of the unit; a diffusing means including a primary diffusing reflector and a secondary diffusing reflector disposed adjacent the display panel, wherein the primary diffusing reflector extends transversely away from the display panel; and a source of optical radiation spaced from the diffusing means, the source of optical radiation having an emitting side that faces in a lateral direction with respect to the extent of the display panel and towards the primary diffusing reflector and so that optical radiation from the source of optical radiation is directed toward the primary diffusing reflector.

In another embodiment, a display unit comprises: a display panel including a graphical information display area for displaying graphical information to a user of the unit; a diffusing means including a primary diffusing reflector and a secondary diffusing reflector disposed adjacent the display panel, wherein the primary diffusing reflector extends transversely away from the display panel; and a source of optical radiation supported by a carrier and spaced from the diffusing means, the source of optical radiation having an emitting side that faces in a lateral direction with respect to the extent of the display panel and towards the primary diffusing reflector and so that optical radiation from the source of optical radiation is directed toward the primary diffusing reflector.

In yet another embodiment a display unit comprises a display panel including a graphical information display area for displaying graphical information to a user of the unit and an optical system for providing diffuse back-light illumination to the display area, the optical system including a source of optical radiation and a diffusing means for diffusing the optical radiation, the diffusing means including at least one diffusing reflector behind the display panel, wherein the at least one diffusing reflector includes a primary diffusing reflector, the primary diffusing reflector extending transversely away from the display panel, and the source of optical radiation is spaced from the diffusing means and includes at last one light emitting diode having an emitting side that faces in a lateral direction with respect to the extent of the display panel and towards the primary diffusing reflector and so that the optical radiation from the LED falls initially on the primary diffusing reflector.

The invention offers a number of advantages. The direction of the emitted optical radiation towards the primary diffusing reflector prevents direct un-diffused illumination emitted by the LED from reaching the graphical information display areas, and this helps to ensure evenness of illumination.

Other advantages stem from the lateral direction of the emitted optical radiation from the primary diffuser. The optical radiation from an LED will naturally have a certain spread, for example about a beam axis, which is preferably oriented to be normal to the primary diffuser surface. Optical radiation from the LED traveling in a direction laterally away from the graphical information display area will then be essentially entirely incident on the primary diffuser reflector, which preferably bounds along one side of the graphical information display area. The diffuse reflector, being oriented transverse, and most preferably perpendicular, to the display panel will therefore also diffusely reflect the optical radiation, primarily in a direction that is oppositely lateral to the direction of the optical radiation originally incident on the primary diffusive reflector. The predominantly lateral direction of both the incident optical radiation and diffuse reflection helps to spread the optical radiation over the display panel and graphical information areas while minimizing the size of the display unit in the direction transverse to the display panel. As a result, the thickness and complexity of the display unit can be minimized and the number of LEDs reduced whilst providing an even back-lighting for the graphical information display area. To help further minimize the required thickness of the display unit, the primary diffusing reflector may be located immediately behind the graphical information display area.

In a preferred embodiment of the invention, the LED is a side-emitting LED. This is particularly suitable for providing the laterally directed illumination described above.

Also in a preferred embodiment of the invention, the display unit comprises additionally a carrier for supporting the (or each) LED. The carrier, which may be a printed circuit board (PCB), includes traces for powering the LED. The LED is then electrically mounted on the carrier with and emitting side of the LED extending upright from the carrier and facing towards the primary diffusing reflector. The carrier will most commonly be a planar carrier, although this may be shaped as required to fit with other adjacent components of the display unit.

The primary diffusing reflector may adjoin the carrier and/or the display panel.

The optical diffusing system may include a secondary diffusing reflector that is arranged to receive at least some of the optical radiation diffused by the primary diffusing reflector and to reflect this optical radiation towards the display panel. In a preferred embodiment of the invention, the (or each) LED is located between the primary and secondary diffusing reflectors.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a partially cut-away perspective view of a display unit according to an embodiment of the present invention; and

FIG. 2 is a cross-section view of the display unit of FIG. 1

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

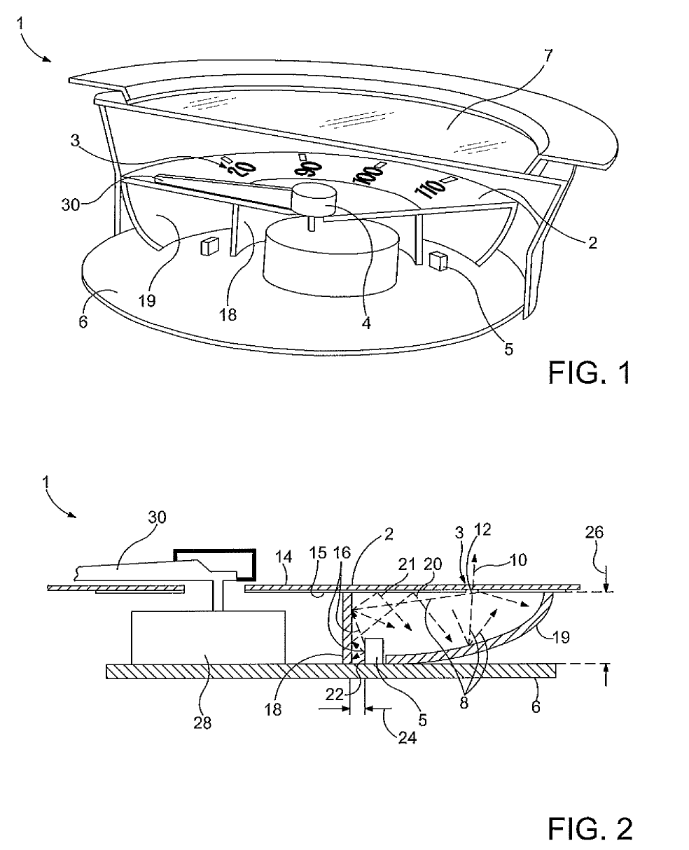

FIGS. 1 and 2 show a display unit 1 including a display panel 2 having a graphical information display area 3 for displaying graphical information to a user of the unit. An optical system is used to provide diffuse back-light illumination 8 to the display area 3. As shown, a portion 10 of the back-light illumination 8 passes through a plurality of areas 12 of relatively high transmittance in the display panel 2 to present graphical information to a user of the display unit 1.

The display panel 2 has a translucent upper layer 14 a lower side of which is covered by one of more layers of an opaque paint 15. The paint 15 is absent in the areas 12 having relatively higher transmittance. A transparent cover 7 protects the translucent front panel layer 14 bearing the graphical information display area 3.

The optical system of the display unit 1 includes up to six, but preferably four, side-emitting LEDs 5 to provide an optical radiation 16 that is used to provide the back-light illumination 8 to the display panel 2. However, other sources of the optical radiation 16 may be used. Diffusing means are provided for diffusing the optical radiation, including a plurality of diffusing reflectors 18, 19 disposed behind the display panel 2.

One of the reflectors is a primary diffusing reflector 18 on which the optical radiation 16 from the LEDs 5 is directly incident. The other of the diffusing reflectors 18, 19 is a secondary diffusing reflector 19 arranged to receive and reflectively diffuse the optical radiation 16 previously scattered by the primary diffusing reflector 18 and the paint coat 15, which preferably includes an outermost painted layer that is highly efficient at reflectively scattering the wavelengths of the optical radiation 20 and 21 received from the primary diffusing reflector 18. As viewed in the cross-section of FIG. 2, which is section perpendicular to the extent of the display panel, the primary diffusing reflector 18 is straight and the secondary diffusing reflector 19 is concave. The primary diffusing reflector 18 and the secondary diffusing reflector 19 are preferably made of an opaque material, such as but not limited to ABS, which has a high diffusive reflection coefficient at the wavelengths of the light sources.

As can be seen most clearly in FIG. 2, the primary diffusing reflector 18 extends perpendicularly away from the display panel 2. The LEDs 5 are mounted on a common printed circuit board (PCB) carrier 6, with an emitting side 22 of each of the LEDs 5 facing directly towards the primary diffusing reflector 18. The emitting side 22 of each of the LEDs 5 is separated from the primary diffusing reflector 18 by a gap 24 of about 3 mm. However, other gap distances may be used.

FIG. 1 illustrates the primary and secondary diffusing reflectors 18, 19 each extending in an arc around the display panel 2, with both the primary and secondary diffusing reflectors 18, 19 extending between the display panel 2 and the carrier 6. As shown, the LEDs 5 are evenly spaced apart in a concentric arrangement between the arcs of the diffusing reflectors 18, 19. However, other patterns may be used.

In certain embodiments, the display unit 1 is a dial display unit including a pointer indicator 30 and a motive means 28 for rotationally moving the pointer indicator 30. As a non-limiting example, the motive means 28 is a stepper motor for controlling the rotational movement of the pointer 30, wherein the pointer 30 indicates the graphical information 3 on the display panel 2. As shown, the dial display unit 1 is a motor vehicle speedometer and the graphical information is the indicated speed of the vehicle. However, other display units and graphical information may be use. As a non-limiting example, the motive means 28 is mounted on the same PCB 6 as used to mount the LEDs 5, and is located inside the arc of the primary diffusing reflector 18. Additionally, the space in which the motive means 28 is housed is bounded laterally by the primary diffusing reflector 18.

In use, the LEDs 5 generate the optical radiation 16 which is directed by the diffusing reflectors 18, 19 to provide the back-light illumination 8 to the display panel 2. Additionally, the motive means 28 sweeps the pointer 30 over an angle of the display panel 2 over which the graphical information 3 extends. As a non-limiting example, graphical information 3 may extend over approximately 280 degrees of the display panel 2. As such, the LEDs 5 and primary and secondary diffusers 18, 19 do not need to extend around a full circle (i.e. 380 degrees). For example, the LEDs 5 and the primary and secondary diffusers 18, 19 extend along an arc over about 300 degrees, leaving a 60 degree section of the display panel 2 (not illustrated) for warning lights associated with other vehicular display components.

Both the PCB carrier 6 and the display panel 2 are planar and parallel with each other and separated by a gap 26 of about 15 mm. The primary diffusing reflector 18 therefore extends substantially perpendicularly between the display panel 2 and the PCB carrier 6. The emitting side 22 of each LED 5 is therefore perpendicular to the plane of the display panel 2 and parallel with the primary diffusing reflector 18. As a result, the emitting side 22 of the LED 5 faces in a lateral direction with respect to the extent of the display panel 2 and towards the primary diffusing reflector 18 so that optical radiation from each LED 5 falls initially on the primary diffusing reflector 18.

The use of predominantly lateral diffusion of the optical radiation 16 helps to minimize the size of the display unit 1 in the direction transverse to the display panel 2. As an example, the vehicular main gauge described above requires four to six LED light sources 5 for a typical architecture profile of 15 mm depth (distance between the PCB carrier 6 and the appliqué graphics 15). Even with four LED light sources 5 the invention will in many cases achieve better illumination homogeneity than conventional illumination systems within a reduced depth profile.

The present invention therefore provides a convenient, economical back-lit display unit 1, with good illumination homogeneity and within a compact depth profile, for example for use in vehicle instrument clusters.

The invention helps to reduce the number of LED 5 sources while maintaining good illumination evenness. The present invention preferably uses a side-emitting type LED to obtain uniform illumination. As shown in the attached drawings, the side-emitting LEDs 5 are placed on the PCB carrier 6 and oriented in such a way that the emitted light 16 undergoes multiple reflections and diffusion towards the dial display plate 2 so that back-light illumination 8 is evenly distributed and a uniform illumination of the information graphical information display area 3 is achieved.

The invention also benefits from the use of a common PCB carrier 6 that supports the LEDs 5 in an orientation in which the optical radiation 16 is emitted towards the primary diffusing reflector 18 and away from the graphical information display area 3. The carrier 6 is also used as one of the supports for the primary and secondary diffusers 18, 19, as well as the motive means 28. Optionally, areas of the carrier 6 exposed to the optical radiation 16 can be coated with a reflective coating (not shown) to aid diffusion of the optical radiation 16 towards the graphical information areas 3. The primary and secondary diffusing reflectors 18, 19, the reflective under-coating 15 of the display panel 2, and optionally also a reflective coated carrier 6 therefore form an efficient “light box” type of optical diffusing system.

The present invention also provides ample space around the pointer 30, which can be used to house warning lights or other display components

The invention therefore provides a number of benefits over certain prior art gauges or other types of display, and achieves a reduction in the number or LED light sources, in this example to four, whilst maintaining even illumination across the graphical display area of a display panel. This, together with a relatively simple construction helps to reduce manufacturing cost.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A display unit comprising:
a display panel including a graphical information display area for displaying graphical information to a user of the unit;
a diffusing means including a primary diffusing reflector and a secondary diffusing reflector disposed adjacent the display panel, wherein the primary diffusing reflector extends transversely away from the display panel; and
a source of optical radiation spaced from the diffusing means, the source of optical radiation having an emitting side that faces in a lateral direction with respect to the extent of the display panel and towards the primary diffusing reflector and so that optical radiation from the source of optical radiation is directed toward the primary diffusing reflector.

2. The display unit according to claim 1, wherein the source of optical radiation is a side-emitting LED.

3. The display unit according to claim 1, wherein the primary diffusing reflector is disposed adjacent the graphical information display area.

4. The display unit according to claim 1, wherein the primary diffusing reflector is coupled to the display panel.

5. The display unit according to claim 1, further comprising a carrier for supporting the source of optical radiation, wherein the carrier includes circuit traces for powering the source of optical radiation and the source of optical radiation is electrically mounted on the carrier with an emitting side of the source extending from the carrier and facing towards the primary diffusing reflector.

6. The display unit according to claim 5, wherein the primary diffusing reflector is coupled to the carrier.

7. The display unit according to claim 1, further comprising a carrier for supporting the source of optical radiation, wherein the carrier supports the source in an orientation in which optical radiation is emitted towards the primary diffusing reflector and away from the graphical information display area and the primary diffusing reflector extends between the display panel and the carrier.

8. The display unit according to claim 7, wherein the display panel and the carrier are substantially parallel with one another, and the primary diffusing reflector extends substantially perpendicularly between the display panel and the carrier.

9. The display unit according to claim 7, wherein the secondary diffusing reflector extends between the display panel and the carrier.

10. The display unit according to claim 1, wherein the secondary diffusing reflector is arranged to receive at least some of the optical radiation diffused by the primary diffusing reflector and to reflect the at least some of the optical radiation towards the display panel.

11. The display unit according to claim 1, wherein the source is located between the primary and secondary diffusing reflectors.

12. The display unit according to claim 1, wherein the primary diffusing reflector is straight and the secondary diffusing reflector is concave in respect of the display panel.

13. The display unit according to claim 1, wherein the primary diffusing reflector extends along an arc with an annular array of sources of optical radiation disposed therearound.

14. The display unit according to claim 13, wherein the display unit is a dial display unit further comprising a pointer indicator and a motive means for rotationally moving the pointer indicator, wherein the motive means is located inside the arc of the primary diffusing reflector.

15. A display unit comprising:
a display panel including a graphical information display area for displaying graphical information to a user of the unit;
a diffusing means including a primary diffusing reflector and a secondary diffusing reflector disposed adjacent the display panel, wherein the primary diffusing reflector extends transversely away from the display panel; and
a source of optical radiation supported by a carrier and spaced from the diffusing means, the source of optical radiation having an emitting side that faces in a lateral direction with respect to the extent of the display panel and towards the primary diffusing reflector and so that optical radiation from the source of optical radiation is directed toward the primary diffusing reflector.

16. The display unit according to claim 15, wherein the primary diffusing reflector is straight and the secondary diffusing reflector is concave in respect of the display panel.

17. The display unit according to claim 15, wherein the carrier for supporting the source of optical radiation includes circuit traces for powering the source of optical radiation and the source of optical radiation is electrically mounted on the carrier with an emitting side of the source of optical radiation extending away from the carrier and facing towards the primary diffusing reflector.

18. The display unit according to claim 15, wherein the carrier supports the source of optical radiation in an orientation in which optical radiation is emitted towards the primary diffusing reflector and away from the graphical information display area and the primary diffusing reflector extends between the display panel and the carrier.

19. The display unit according to claim 15, wherein the source of optical radiation is located between the primary and secondary diffusing reflectors.

20. A display unit comprising a display panel including a graphical information display area for displaying graphical information to a user of the unit and an optical system for providing diffuse back-light illumination to the display area, the optical system including a source of optical radiation and a diffusing means for diffusing the optical radiation, the diffusing means including at least one diffusing reflector behind the display panel, wherein the at least one diffusing reflector includes a primary diffusing reflector, the primary diffusing reflector extending transversely away from the display panel, and the source of optical radiation is spaced from the diffusing means and includes at last one light emitting diode having an emitting side that faces in a lateral direction with respect to the extent of the display panel and towards the primary diffusing reflector and so that the optical radiation from the light emitting diode falls initially on the primary diffusing reflector.
